(19) United States
(12) Patent Application Publication
(10) Pub. No.: US 2023/0217959 A1
(43) Pub. Date: Jul. 13, 2023

(54) DOG BISCUIT

(71) Applicants: Hillel Trope, Dix Hills, NY (US); Michelle Brosdale, Dix Hills, NY (US)

(72) Inventors: Hillel Trope, Dix Hills, NY (US); Michelle Brosdale, Dix Hills, NY (US)

(21) Appl. No.: 18/153,873

(22) Filed: Jan. 12, 2023

Related U.S. Application Data
(60) Provisional application No. 63/298,767, filed on Jan. 12, 2022.

(51) Int. Cl. A23K 10/30; A23K 20/189; A23K 10/18; A23K 20/163; A23K 20/174; A23K 10/20; A23K 20/105; A23K 50/42

(52) U.S. Cl. CPC A23K 10/30; A23K 10/18; A23K 10/20; A23K 20/105; A23K 20/163; A23K 20/174; A23K 20/189; A23K 50/42

(57) ABSTRACT

A dog biscuit, such as a morning dog biscuit or an evening dog biscuit, that includes a botanical; a botanical seed or vegetable seed; a digestive enzyme or coenzyme; a probiotic or prebiotic; a vitamin; an animal organ; an egg yolk; a fruit or vegetable; and a bone broth.

The exemplary embodiments of the present invention relate generally to a snack intended for consumption by any animal, such as a pet, and referred to herein as a dog biscuit.

### BACKGROUND OF THE DISCLOSURE

Pets, particularly dogs, provide an immeasurable benefit to their owners, who in turn, have the desire to improve and maintain optimal health and wellness for their companions. There remains a need for healthy pet food and snacks and treats, including dog snacks or treats that are specially formulated for administration early in the day, and near bedtime.

### BRIEF SUMMARY OF THE DISCLOSURE

In accordance with an exemplary embodiment of the subject disclosure, there is provided a dog biscuit that includes a grain component (e.g., containing oats such as ground oats), a fruit or vegetable component and an animal organ component. In one embodiment, the dog biscuit includes a botanical, a botanical seed or a vegetable seed, a digestive enzyme or coenzyme; a probiotic or prebiotic; a vitamin; an animal organ; an egg yolk; a fruit or vegetable; and a bone broth. In one exemplary embodiment, the dog biscuit further includes astaxanthin. In another exemplary embodiment, the dog biscuit includes egg shell membrane.

In an exemplary embodiment, the botanical or vegetable seed includes one or more botanical or vegetable seeds selected from the group consisting of oats, quinoa seeds, chia seeds, hemp seeds, and pumpkin seeds.

In an exemplary embodiment, the botanical includes one or more botanicals selected from the group consisting of arnica, barley grass, cinnamon, echinacea, ginger, parsley, fennel, moringa leaves, hemp oil, and spirulina.

In an exemplary embodiment, the digestive enzyme includes one or more digestive enzymes selected from the group consisting of a protease, a lipase, and an amylase.

In an exemplary embodiment, the prebiotic or probiotic includes one or more prebiotics or probiotics selected from the group consisting of a Bifidobacterium bacteria, a Lactobacillus bacteria, a Streptococcus bacteria, and arabinogalactan.

In an exemplary embodiment, the vitamin includes one or more vitamins selected from the group consisting of vitamin E, vitamin C, and vitamin A.

In an exemplary embodiment, the animal organ includes one or more animal organs selected from the group consisting of chicken heart, chicken liver, and chicken gizzard.

In an exemplary embodiment, the fruit or vegetable includes one or more fruits and vegetables selected from the group consisting of apples, blackberries, blueberries, cantaloupe, carrots, celery, cranberries, cucumbers, green (snap) beans, mangos, papaya, pineapple, pumpkin, raspberries, strawberries, and watermelon.

In an exemplary embodiment, the bone broth includes one or more bone broths selected from the group consisting of chicken bone broth, and beef bone broth. In an exemplary embodiment, the dog biscuit includes a second source of glucosamine.

In accordance with another exemplary embodiment of the subject disclosure, there is provided a dog biscuit that includes ground oats; a digestive enzyme or coenzyme; a probiotic or prebiotic; a vitamin E; chicken organs; an egg yolk; at least one bushberry; an apple; and a bone broth. In an exemplary embodiment, the chicken organs includes one or more of chicken hearts, chicken liver and chicken gizzards.

In an exemplary embodiment, the bushberry is one or more bushberries selected from the group consisting of raspberries, blackberries, and blueberries.

In an exemplary embodiment, the dog biscuit includes one or more vegetables selected from the group consisting of watermelons, mangos, cantaloupes, papayas, strawberries, celery, green beans (snaps), carrots, and bushberries.

In another exemplary embodiment, the dog biscuit further includes moringa leaves and/or astaxanthin. In another exemplary embodiment, the dog biscuit includes one or more ground botanicals selected from the ground quinoa, ground chia seeds, and ground barley grass. In one embodiment, the dog biscuit includes barley grass powder. In one embodiment, the dog biscuit includes bovine colostrum, and/or turmeric, and/or liquid echinacea.

In accordance with an exemplary embodiment of the subject disclosure, there is provided a dog biscuit kit that includes a morning dog biscuit and an evening dog biscuit. In one exemplary embodiment, the morning dog biscuit includes ground oat powder; moringa leaves; a digestive enzyme; astaxanthin; a probiotic or prebiotic; vitamin E; chicken organs, for example, comprising substantially equal parts of chicken hearts, chicken liver and chicken gizzards; eggs; a bone broth; and a vegetable mix comprising watermelon, mango, apple, cantaloupe, papaya, strawberries, and a bushberry. In one exemplary embodiment, the evening dog biscuit includes ground oat powder; ground quinoa; ground chia seeds; barley grass powder; bovine colostrum; turmeric; digestive enzymes; probiotics; vitamin E; liquid echinacea; chicken organs comprising substantially equal parts of chicken hearts, chicken liver and chicken gizzards; eggs; a bone broth; and a vegetable mix, for example a vegetable mix comprising celery, apples, green(snap) beans, and a bushberry. In one exemplary embodiment, a container (e.g., a dog biscuit tray) is provided to store the dog biscuit kit.

Other features and advantages of the subject disclosure will be apparent from the following more detailed description of the exemplary embodiments.

### BRIEF DESCRIPTION OF THE SEVERAL VIEWS OF THE DRAWINGS

The foregoing summary, as well as the following detailed description of the exemplary embodiments of the subject disclosure, will be better understood when read in conjunction with the appended drawings. For the purpose of illustrating the present disclosure, there are shown in the drawings, exemplary embodiments. It should be understood, however, that the subject application is not limited to the precise arrangements and instrumentalities shown.

FIG. 1 is a perspective view of a morning dog biscuit and an evening dog biscuit in accordance with an exemplary embodiment of the subject disclosure; and

FIGS. 2 and 3 are perspective and birds eye views of a dog biscuit storage tray, with a plurality of wells intended to each hold a number of biscuits (e.g., 2 biscuits, preferably a morning biscuit and an evening biscuit) with each well denoted to indicate the circumferential shape of a morning and an evening dog biscuit, which is a suggested daily serving amount.

### DETAILED DESCRIPTION OF THE DISCLOSURE

Reference will now be made in detail to the exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1 % from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

“Exemplary” as used herein shall mean “example” only and is not intended to identify any embodiment or structure as preferred or more desirable than any other.

As used herein, the term “botanical” refers to any compound or composition obtained from a non-vegetable, plant or algae source, such as, but not limited to, materials (e.g., spices, extracts, distillates or biomass) obtained from the leaf, flower, stem, bark and/or roots of plants or algae.

The terms “fruits” and “vegetables” are used based on their ordinary meaning and generally includes produce commonly found in grocery stores. The classification of a particular component as a “fruit or vegetable” (vis-a-vi a botanical) shall be determined based on whether the University of California-Davis, College of Agriculture & Environmental Sciences classifies the particular component as a non-ornamental fruit or vegetable, see <http:// http://postharvest.ucdavis.edu/Commodity_Resources/Fact Sheets/>, as of the priority date of this application. Otherwise, the particular component is a botanical.

Throughout this disclosure, various aspects of the exemplary embodiments can be presented in a range format. It should be understood that the description in range format is merely for convenience and brevity and should not be construed as an inflexible limitation on the scope of the exemplary embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments may be combined in any suitable manner in one or more embodiments. One skilled in the relevant art will recognize, in light of the description herein, that the exemplary embodiments can be practiced without one or more of the specific features or advantages of a particular embodiment. In other instances, additional features and advantages may be recognized in certain embodiments that may not be present in all embodiments of the subject disclosure.

The ingredients described herein can be provided in a dried (e.g., desiccated and/or in the form of powder or flour) or fresh form, or in any form between dry and fresh (e.g., 50% dry). Accordingly, reference to, for example, a fruit or any other ingredient, should be construed as a reference to the fruit (or ingredient) in a fresh form, or a partially or completely dried form of the fruit (or ingredient). Similarly with respect to grain components (e.g., oats, quinoa, etc.), the grains can be added whole, rolled, or ground into a powder (i.e., a flour).

In certain embodiments, the dog biscuit includes, as an ingredient, apples or a component obtained from apples (e.g., red delicious apples). In certain embodiments, the seeds and core of the apple are removed.

In certain embodiments, the dog biscuit includes, as an ingredient, a component obtained from arnica. In certain embodiments, the dog biscuit includes a root and/or flower of arnica.

In certain embodiments, the dog biscuit includes, as an ingredient, astaxanthin. In one embodiment, the astaxanthin is obtained from algae. In one embodiment, the astaxanthin is obtained from a seafood source, such as wild sockeye salmon, red trout, shrimp, and/or crab. In certain embodiments, the astaxanthin is not obtained synthetically, but is obtained from a natural source (e.g., algae).

In certain embodiments, the dog biscuit includes, as an ingredient, barley grass or a component obtained from barley grass.

In certain embodiments, the dog biscuit includes, as an ingredient, blackberries, or a component obtained from blackberries.

In certain embodiments, the dog biscuit includes, as an ingredient, blueberries, or a component obtained from blueberries.

In certain embodiments, the dog biscuit includes, as an ingredient, bone broth. In certain embodiments, the bone broth is obtained from one or more of chicken bones, and cow bones.

In certain embodiments, the dog biscuit includes, as an ingredient, cantaloupe, or a component obtained from cantaloupe.

In certain embodiments, the dog biscuit includes, as an ingredient, celery, or a component obtained from celery.

In certain embodiments, the dog biscuit includes, as an ingredient, chia seeds, or a component obtained from chia seeds.

In certain embodiments, the dog biscuit includes, as an ingredient, cinnamon, or a component obtained from a cinnamon tree. In one embodiment, the cinnamon is obtained from Cinnamomum verum, also called a true cinnamon true or a Ceylon cinnamon tree. In one embodiment, the cinnamon is from a Cinnamomum specie or species besides Cinnamomum cassia (also called Chinese cassia, Chinese cinnamon, and cassia cinnamon).

In certain embodiments, the dog biscuit includes, as an ingredient, colostrum, or a component obtained from female mammals immediately after giving birth. In one embodiment, the colostrum is bovine colostrum.

In certain embodiments, the dog biscuit includes, as an ingredient, Coenzyme Q10 (also known as ubiquinone or CoQ10).

In certain embodiments, the dog biscuit includes, as an ingredient, cranberries, or a component obtained from cranberries. In one embodiment, the cranberries are dried cranberries.

In certain embodiments, the dog biscuit includes, as an ingredient, a cucumber, or a component obtained from cucumbers. In one embodiment, the cranberries are dried cucumbers.

In certain embodiments, the dog biscuit includes, as an ingredient, a cucumber, or a component obtained from cucumbers. In one embodiment, the cranberries are dried cucumbers.

In certain embodiments, the dog biscuit includes, as an ingredient, a carrot, or a component obtained from carrots. In one embodiment, the cranberries are dried cucumbers.

In certain embodiments, the dog biscuit includes, as an ingredient, digestive enzymes. In one embodiment, the digestive enzyme includes one or more of a protease, a lipase, and an amylase. In one embodiment, the digestive enzyme is a fermentation product obtained from an aspergillus genus, such as a fermentation obtained from aspergillus oryzae (e.g., Aspergillus oryzae NRRL 458). Digestive enzymes for use in the presently disclosed subject matter can be obtained commercially (e.g., Anaferm® commercially available from BioZyme, Inc.).

In certain embodiments, the dog biscuit includes, as an ingredient, a plant (e.g., root) from the echinacea genus, or a component obtained from a plant of the echinacea genus. For example, in one embodiment, the dog biscuit includes an ingredient obtained from the root of echinacea (e.g., one or more of echinacea purpurea, echinacea angustifolia and echinacea pallida).

In certain embodiments, the dog biscuit includes, as an ingredient, eggs, or a component obtained from egg whites or egg yolks. In one embodiment the eggs are chicken eggs. The eggs can be, for example, in fresh form, or can be in the form a dried egg product.

In certain embodiments, the dog biscuit includes, as an ingredient, egg shell membranes, or a component obtained from egg shell membranes. In one embodiment the egg shells are chicken egg shells.

In certain embodiments, the dog biscuit includes, as an ingredient, fennel, or a component obtained from fennel.

In certain embodiments, the dog biscuit includes, as an ingredient, ginger root, or a component obtained from ginger root.

In certain embodiments, the dog biscuit includes, as an ingredient, the dog biscuit includes glucosamine, and/or a salt of glucosamine (e.g., glucosamine sulfate, glucosamine hydrochloride), and/or a derivative of glucosamine (e.g., N-Acetyl-Glucosamine), and/or a component obtained from the hydrolysis of shellfish exoskeletons. The glucosamine, as described above, can be prepared synthetically, or obtained from natural sources.

In certain embodiments, the dog biscuit includes green beans (also regionally colloquially-known as snaps, snap beans, string beans and French beans), or a component obtained from green beans.

In certain embodiments, the dog biscuit includes green-lipped mussels, or a component obtained from green-lipped mussels.

In certain embodiments, the dog biscuit includes hemp seeds, or a component obtained from hemp seeds (e.g., hemp seed oil).

In certain embodiments, the dog biscuit includes, as an ingredient, mangoes, or a component obtained from mangoes.

In certain embodiments, the dog biscuit includes, as an ingredient, a mint leaf or a component obtained from mint. In one embodiment, the dog biscuit includes menthol, either as obtained from mint or added as a separate (e.g., synthetic) component.

In certain embodiments, the dog biscuit includes, as an ingredient, moringa leaf, or a component obtained from moringa leaf or the moringa oleifera tree. In certain embodiments, the dog biscuit includes up to ⅛ teaspoon, ¼ teaspoons, ½ teaspoons, 1 teaspoon, 2 teaspoons, or 1 tablespoon of moringa leaf per dog biscuit. As is generally the case with all the ingredients described herein, the moringa leaf can, in certain embodiments, be added to the dog biscuit in a dried form and/or in the form of a powder.

In certain embodiments, the dog biscuit includes, as an ingredient, oats, or a component obtained from oats (e.g., oatmeal). The oats can, in certain embodiments, in the form of a flour.

In certain embodiments, the dog biscuit includes, as an ingredient, organ meat, or a component obtained from organ meat. In one embodiment, the organ meat is selected from chicken livers and chicken hearts.

In certain embodiments, the dog biscuit includes, as an ingredient, papaya or a component obtained from papaya.

In certain embodiments, the dog biscuit includes, as an ingredient, parsley or a component obtained from parsley.

In certain embodiments, the dog biscuit includes, as an ingredient, phytoplankton, or a component obtained from phytoplankton. In one embodiment, the dog biscuit includes up to 1/32 teaspoon or 1/16 teaspoon of phytoplankton per day.

In certain embodiments, the dog biscuit includes, as an ingredient, pineapple, or a component obtained from pineapple. In one embodiment, the pineapples are dried pineapples.

In certain embodiments, the dog biscuit includes, as an ingredient, a prebiotic, i.e., a substrate that is selectively used by a host microorganism to produce a health benefit; see Nature Reviews. Gastroenterology & Hepatology. 14(8): 491-502 (2017). In certain embodiments, the prebiotic feeds or is otherwise conducive towards the growth of beneficial bacteria (i.e., prebiotics), such as, but not limited to Bifidobacterium and Lactobacillus bacteria, including prebiotic strains normally present in an animal’s (e.g., dog’s) gut.

In certain embodiments, the dog biscuit includes, as an ingredient, a probiotic, i.e., a beneficial bacteria (i.e., prebiotics), such as, but not limited to Bifidobacterium, Lactobacillus and Enterococcus genus bacteria, including probiotic strains normally present in an animal’s (e.g., dog’s) gut. In one embodiment, the dog biscuit includes Love Bugs, commercially available from Adored Beast Apothecary and containing a mixture of 14 prebiotics and probiotics. In another embodiment, the dog biscuit includes a fermentation product of one or more of lactobacillus acidophilus, lactobacillus casei, bifobacterium thermophilum and enterococcus faecium.

In certain embodiments, the dog biscuit includes, as an ingredient, arabinogalactan, or a component obtained from the wood of a larch tree (Larix species).

In certain embodiments, the dog biscuit includes, as an ingredient, pumpkin, or a component obtained from pumpkin (e.g., pumpkin seeds). In one embodiment, the pumpkins are dried pumpkins.

In certain embodiments, the dog biscuit includes, as an ingredient, quinoa, or a component obtained from quinoa.

In certain embodiments, the dog biscuit includes, as an ingredient, raspberries, or a component obtained from raspberries. In one embodiment, the raspberries are dried raspberries.

In certain embodiments, the dog biscuit includes, as an ingredient, spirulina, or a component obtained from the biomass of cyanobacteria. In one embodiment, the dog biscuit includes sprirulina obtained from, or a component obtained from one or more of Arthrospira platensis, Arthrospira fusiformis and Arthrospira maxima.

In certain embodiments, the dog biscuit includes, as an ingredient, strawberry, or a component obtained from strawberries. In one embodiment, the strawberries are dried strawberries.

In certain embodiments, the dog biscuit includes, as an ingredient, watermelon, or a component obtained from watermelons. In one embodiment, the watermelons are dried watermelons.

The dog biscuits of the subject disclosure include one or more ingredients from organic sources, and can, in exemplary embodiments, yields, upon administration to an animal (e.g., a dog), amounts of omega fatty acids 3 and 6. In certain embodiments, the dog biscuit yields, upon administration to an animal, an anti-oxidant profile that includes one or more of beta hydroxy acid (BHA), butylated hydroxytoluene (BHT), tert-butylhydroquinone (TBHQ) and propyl gallate. In other exemplary embodiments, the dog biscuit includes one or more vitamins selected from Vitamin A, Vitamin C and Vitamin E. In one embodiment, the dog biscuit includes only ingredients and components that have been designated GRAS and/or endorsed or reviewed by the Association of American Feed Control Officials (AAFCO), and/or includes only ingredients and components consistent with GRAS and/or AAFCO standards or guidelines.

The caloric content of the dog biscuit can vary. In certain embodiments, caloric content of the morning dog biscuit and/or the evening dog biscuit can range from about 5-100 kcal/biscuit, or from about 10-75 kcal/ biscuit, or from about 20-60 kcal/ biscuit. In one embodiment, the morning dog biscuit has caloric content of about 40-50 kcal/ biscuit and the evening dog biscuit has a caloric content of about 35-45 kcal/biscuit. In one embodiment, the morning dog biscuit has a caloric content of 43.7-48.3 kcal/biscuit, or 41.4-50.6 kcal/biscuit, or 36.8-55.2 kcal/biscuit; and/or the evening dog biscuit has a caloric content of 36.1-39.9 kcal/biscuit, or 34.2-41.8 kcal/biscuit or 30.4-45.6 kcal/biscuit.

In certain exemplary embodiments, the dog biscuits are intended to be administered twice daily, with a morning dog biscuit administered in the morning (e.g., within an hour of waking from a conventional night’s sleep) and the evening dog biscuit in the evening prior to the owner retiring for the day. Other administration schedules can be envisioned based on the schedule of the dog owner. A kit can be provided which contains receptacles to house the morning dog biscuit and the evening dog biscuit.

In certain exemplary embodiments, the morning dog biscuit contains a higher caloric content than the evening dog biscuit. For example, and not limitation, the ratio of the caloric content of the morning biscuit:evening biscuit is 1.01-1.9, or 1.05-1.8, or 1.1-1.35, or about 1.2 in certain exemplary embodiments.

In certain exemplary embodiments, the morning biscuit is particularly intended to contain at least one of, or each of, a vitamin (e.g., an antioxidant), a digestive enzyme, and a prebiotic or probiotic; and/or the evening biscuit is particularly intended to contain an ingredient to support immune health against virus and disease (e.g., cancer), such as, but not limited to, colostrum (e.g., bovine colostrum), coenzyme Q10 (also known as ubiquinone or CoQ10). Accordingly, the morning dog biscuit can provide the dog energy for the day, and allow the dog to burn off the calories before bed, and the evening dog biscuit can support the dog’s immune health against sickness and disease such as cancer while it sleeps and recovers from the day’s activities.

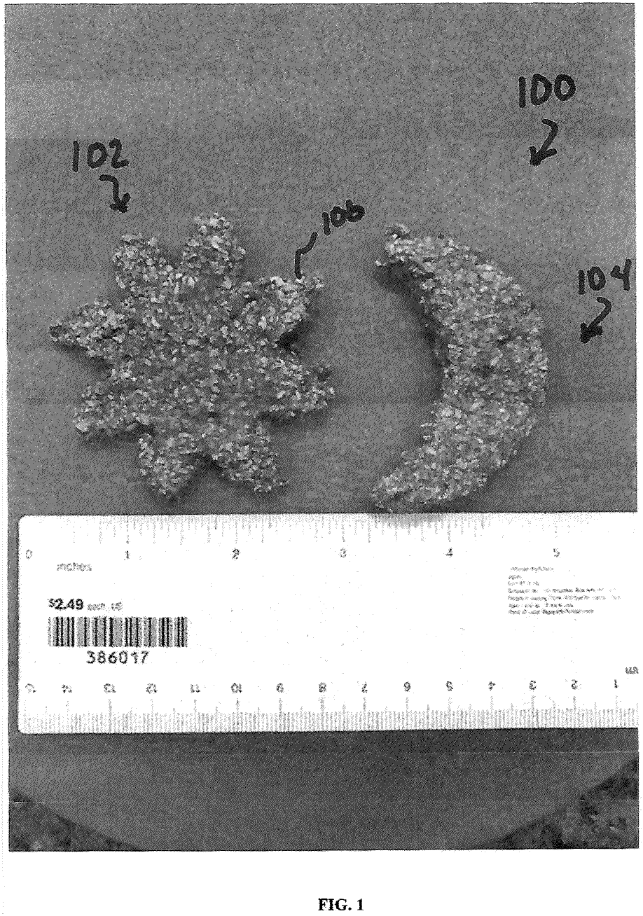

Referring to FIG. 1. a dog biscuit kit 100 that includes morning dog biscuit 102 and an evening dog biscuit 104. The morning dog biscuit is in shape or design that is indicative of the morning, such as the shape of a sun with rays or projections 106. The morning dog biscuit 102 has a size capable of being held in one hand, having in this exemplary embodiment, a height and width of about 3 inches. Other shapes and sizes can alternatively be provided.

The evening dog biscuit 104 is in shape or design that is indicative of the evening, such as the shape of a moon (e.g., a waxing or waning crescent moon). The evening dog biscuit 104 also has a size capable of being held in one hand, having a height of about 3 inches and a width of about 1.5 or 2 inches. Other shapes and sizes can alternatively be provided.

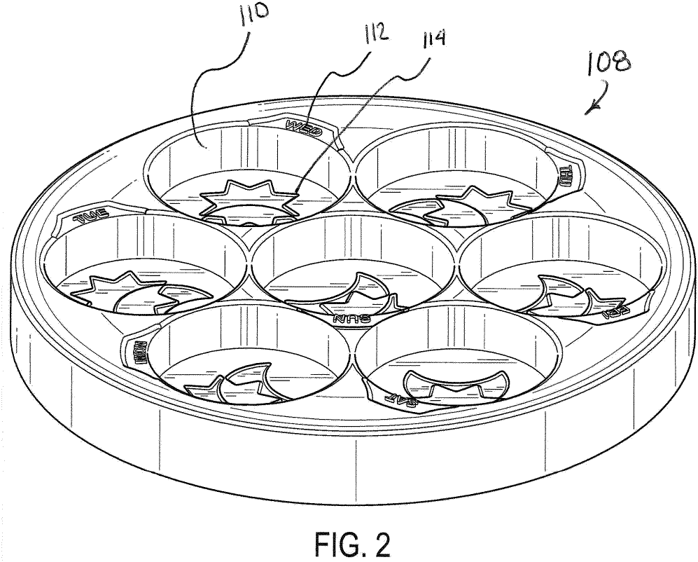

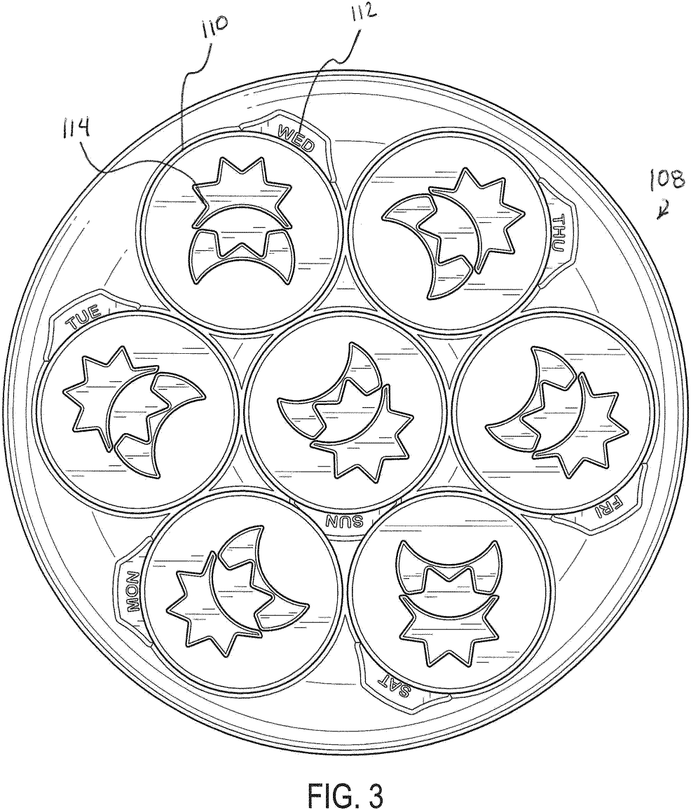

As shown in FIGS. 2 and 3, the morning dog biscuit 102 and the evening dog biscuit 104 can be housed in a tray 108, which can be composed of tin, metal, plastic or other suitable material. Tray 108 contains a plurality of wells 110 sized to receive one or more dog biscuits. In this exemplary embodiment seven wells 110 are provided to correspond to a week’s supply of dog biscuits, each well being provided with a three-letter designation 112 corresponding to a day of the week. The bottom of the wells contain a design or indicia 114 indicative of the shape of one or more dog biscuits. In this exemplary embodiment, each well 110 of the tray 108 can contain one morning dog biscuit 102 and one evening dog biscuit 104.

### Example 1 - Morning Dog Biscuit

Whole oats are ground into a powder and measured to an amount based on a handheld final serving size. Moringa leaves, enzymes (e.g., digestive enzymes), astaxanthin, probiotics and Vitamin E tocopherols are added to the oat powder.

1 cup of organ pate is prepared by grinding in a blender ⅓ cup of chicken hearts, ⅓ cup of chicken liver, ⅓ cups of chicken gizzards and 2 eggs.

A fruit mix is prepared in a blender from watermelon, mango, peeled red delicious apple, cantaloupe, papaya, blueberries, strawberries, raspberries, blackberries, bone broth (homemade broth using beef and chicken bones). One cup of the fruit mix is prepared from these ingredients.

The fruit mix, organ pate and whole oat powder mixture is mixed and can be baked at a suitable temperature (e.g., at least 10-15 minutes at about 400° F.).

### Example 2 - Evening Dog Biscuit

Whole oats, quinoa and chia seeds are ground to a powder. Barley grass powder, bovine colostrum, turmeric, enzymes, probiotics, Vitamin E tocopherols, and liquid echinacea are added to the powder mixture.

1 cup of organ pate is prepared by grinding in a blender ⅓ cup of chicken hearts, ⅓ cup of chicken liver, ⅓ cups of chicken gizzards and 2 eggs.

A fruit mix is prepared in a blender from raspberries, blackberries, celery, peeled red delicious apples, green beans, blueberries, carrots, and bone broth (homemade broth using beef and chicken bones). One cup of the fruit mix is prepared from these ingredients.

The fruit mix, organ pate and powder mixture can be combined and baked, such as described in Example 1.

### Example 3 - Morning Dog Biscuit

A morning dog biscuit is prepared with ingredients in the amounts set forth below, as generally described in Example 1:

| Ingredient | Relative Amount (wt%) |
|---|---|
| Oat Flour, whole | 42.530 |
| Freeze-Dried Chicken | 13.00000 |
| Organic Steam-Rolled Oats | 13.00000 |
| Coconut Glycerin | 11.100 |
| Dried egg product or whole eggs | 2.200 |
| Fresh Strawberries | 2.17000 |
| Brewers Yeast (Emmert) | 2.00000 |
| Chicken Hearts (fresh or freeze dried) | 2.00000 |
| Chicken Livers (fresh or freeze dried) | 2.00000 |
| Bone Broth (optional) | 2.00000 |
| Fresh Blackberries | 1.83000 |
| Fresh Raspberries | 1.59000 |
| Fresh Blueberries | 1.27000 |
| Dry Vinegar | 1.21300 |
| Dry Moringa leaves | 1.06500 |
| Dry Honey | 0.50000 |
| Dried aspergillus oryzae fermentation product | 0.47700 |
| Astaxanthin | 0.45000 |
| Dry Mango | 0.33700 |
| Dry Apple | 0.24500 |
| Dry Cantaloupe | 0.21000 |
| Dried Lactobacillus Acidophilus Fermentation Product | 0.16600 |
| Dried Lactobacillus casei fermentation product | 0.16600 |
| Dried Bifidobacterium Thermophilum fermentation product | 0.16600 |
| Dried enterococcus faecium fermentation product | 0.16600 |
| Vitamin E (50% dry) | 0.09800 |
| Citric Acid (preservative) | 0.05000 |
| Mixed Tocopherols | |
| Rosemary extract | |
| Total | 100 |

Calorie content: metabolizable energy - calculated; 2770 kcal/kg or 46 kcal/biscuit. Intended for intermittent or supplemental feeding only.

### Example 4 - Evening Dog Biscuit

An evening dog biscuit is prepared with ingredients in the amounts set forth below, as generally described in Example 1:

| Ingredient | Relative amount (wt%) |
|---|---|
| Oat Flour, whole | 28.758 |
| Freeze-Dried Chicken | 13.000 |
| Organic Steam-Rolled Oats | 13.000 |
| Coconut Glycerin | 10.171 |
| Chia Seeds | 4.594 |
| Dry Barley Grass | 3.839 |
| Quinoa Flour | 3.839 |
| Dried egg product or whole eggs | 2.200 |
| Bovine Colostrum (4515) | 2.146 |
| Brewers Yeast (Emmert) | 2.000 |
| Chicken Hearts (fresh or freeze dried) | 2.000 |
| Chicken Liver (fresh or freeze dried) | 2.000 |
| Fresh Raspberries | 1.821 |
| Fresh Blueberries | 1.797 |
| Carrots | 1.495 |
| Fresh Blackberries | 1.438 |
| Fresh Green Beans | 1.198 |
| Dry Vinegar | 1.083 |
| Dried Lactobacillus Acidophilus Fermentation Product | 0.178 |
| Dried Lactobacillus casei fermentation product | 0.178 |
| Dried Bifidobacterium Thermophilum fermentation product | 0.178 |
| Dried enterococcus faecium fermentation product | 0.178 |
| Dry Echinacea Root | 0.715 |
| Fresh Celery | 0.659 |
| Dry Honey | 0.500 |
| Dried aspergillus oryzae fermentation product | 0.477 |
| Dry Apple | 0.288 |
| Turmeric | 0.119 |
| Vitamin E (50% dry) | 0.097 |
| Citric Acid (preservative) | 0.050 |
| Total | 100 |

Calorie content: metabolizable energy - calculated; 2834 kcal/kg or 38 kcal/biscuit. Intended for intermittent or supplemental feeding only.

It will be appreciated by those skilled in the art that changes could be made to the exemplary embodiments described above without departing from the broad inventive concept thereof. It is to be understood, therefore, that the subject disclosure is not limited to the particular exemplary embodiments disclosed, but it is intended to cover modifications within the spirit and scope of the subject disclosure as disclosed above.

1. A dog biscuit comprising:
(a) a botanical;
(b) a botanical seed or vegetable seed;
(c) a digestive enzyme or coenzyme;
(d) a probiotic or prebiotic;
(e) a vitamin;
(f) an animal organ;
(g) an egg yolk;
(h) a fruit or vegetable; and
(i) optionally, a bone broth.

2. The dog biscuit of claim 1, further comprising astaxanthin.

3. The dog biscuit of claim 1, wherein the botanical or vegetable seed includes one or more botanical or vegetable seeds selected from the group consisting of oats, quinoa seeds, chia seeds, hemp seeds, and pumpkin seeds.

4. The dog biscuit of claim 1, wherein the botanical includes one or more botanicals selected from the group consisting of arnica, barley grass, cinnamon, echinacea, ginger, parsley, fennel, moringa leaves, hemp oil, and spirulina.

5. The dog biscuit of claim 1, wherein the digestive enzyme includes one or more digestive enzymes selected from the group consisting of a protease, a lipase, and an amylase.

6. The dog biscuit of claim 1, wherein the digestive enzyme is fermentation product of aspergillus oryzae.

7. The dog biscuit of claim 1, wherein the prebiotic or probiotic includes one or more probiotics selected from the group consisting of a Bifidobacterium bacteria, a Lactobacillus bacteria, a Streptococcus bacteria, an Enterococcus bacteria and arabinogalactan.

8. The dog biscuit of claim 1, wherein the vitamin includes one or more vitamins selected from the group consisting of vitamin E, vitamin C, and vitamin A.

9. The dog biscuit of claim 1, wherein the animal organ includes one or more animal organs selected from the group consisting of chicken heart, chicken liver, and chicken gizzard.

10. The dog biscuit of claim 1, further comprising egg shell membrane.

11. The dog biscuit of claim 1, wherein the fruit or vegetable includes one or more fruits and vegetables selected from the group consisting of apples, blackberries, blueberries, cantaloupe, carrots, celery, cranberries, cucumbers, green(snap)beans, mangos, papaya, pineapple, pumpkin, raspberries, strawberries, and watermelon.

12. The dog biscuit of claim 1, wherein the bone broth includes one or more bone broths selected from the group consisting of chicken bone broth, and beef bone broth.

13. The dog biscuit of claim 1, further comprising a second source of glucosamine.

14. A dog biscuit comprising:
(a) oat flour;
(b) a digestive enzyme or coenzyme;
(c) a probiotic or prebiotic;
(e) a vitamin E;
(f) chicken organs;
(g) an egg yolk;
(h) at least one bushberry;
(i) an apple; and
(j) optionally, a bone broth.

15. The dog biscuit of claim 14, wherein the chicken organs comprise chicken hearts, chicken liver and chicken gizzards.

16. The dog biscuit of claim 14, wherein the bushberry is one or more bushberries selected from the groups consisting of raspberries, blackberries, and blueberries.

17. The dog biscuit of claim 14, further comprising one or more vegetables selected from the group consisting of watermelons, mangos, cantaloupes, papayas, strawberries, celery, green(snap) beans, carrots, and bushberries.

18. The dog biscuit of claim 14, further comprising moringa leaves.

19. The dog biscuit of claim 14, further comprising astaxanthin.

20. The dog biscuit of claim 14, further comprising one or more ground botanicals or ground botanical seeds selected from the ground quinoa, ground chia seeds, and ground barley grass.

21. The dog biscuit of claim 20, wherein the dog biscuit comprises ground quinoa, ground chia seeds, and ground barley grass.

22. The dog biscuit of claim 21, further comprising barley grass powder.

23. The dog biscuit of claim 14, further comprising bovine colostrum.

24. The dog biscuit of claim 14, further comprising turmeric.

25. The dog biscuit of claim 14, further comprising echinacea root.

26. A dog biscuit kit comprising a morning dog biscuit and an evening dog biscuit,
the morning dog biscuit comprising:
(a) oat flour;
(b) freeze dried chicken
(c) rolled oats;
(d) coconut glycerin;
(e) egg;
(f) strawberry;
(g) brewers yeast;
(h) chicken hearts;
(i) chicken livers;
(j) bone broth;
(k) blackberry;
(l) raspberry;
(m) vinegar;
(n) moringa leaf powder;
(o) honey;
(p) dried aspergillus oryzae fermentation product;
(q) astaxanthin;
(r) mango;
(s) apple;
(t) cantaloupe;
(u) dried lactobacillus acidophilus fermentation product;
(v) dried lactobacillus casei fermentation product;
(w) dried bifidobacterium thermophilum fermentation product;
(x) dried enterococcus faecium fermentation product;
(y) vitamin E;
(z) citric acid; and
the evening dog biscuit comprising:
(aa) oat flour;
(bb) freeze dried chicken;
(cc) rolled oats;
(dd) coconut glycerin;
(ee) chia seeds;
(ff) barley grass;
(gg) quinoa;
(hh) egg;
(ii) colostrum;
(jj) brewers yeast;
(kk) chicken heart;
(ll) chicken liver;
(mm) bone broth;
(nn) raspberry;
(oo) blueberry;
(pp) carrots;
(qq) blackberry;
(rr) green bean;
(ss) vinegar;
(tt) echinacea root;
(uu) celery;
(vv) honey;
(ww) dried aspergillus oryzae fermentation product;
(xx) apple;
(yy) dried lactobacillus acidophilus fermentation product;
(zz) dried lactobacillus casei fermentation product;
(aaa) dried bifidobacterium thermophilum fermentation product;
(bbb) dried enterococcus faecium fermentation product;
(ccc) turmeric;
(ddd) vitamin E;
(eee) citric acid.
